(19) United States
(12) Patent Application Publication
(10) Pub. No.: US 2024/0121696 A1
(43) Pub. Date: Apr. 11, 2024

(54) CROSS-LINK SWITCHING BETWEEN TERRESTRIAL AND NON-TERRESTRIAL LINKS IN WIRELESS COMMUNICATION NETWORKS

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 18/391,008

(22) Filed: Dec. 20, 2023

Related U.S. Application Data
(63) Continuation of application No. PCT/CN2021/103223, filed on Jun. 29, 2021.

(51) Int. Cl. H04W 40/02

(52) U.S. Cl. CPC H04W 40/02

(57) ABSTRACT

Cross-link switching between terrestrial and non-terrestrial links in integrated wireless communication networks involves interactions between a user equipment (UE), a terrestrial network device, and a non-terrestrial network device. Signaling is sent by one of the network devices and received by the UE, to schedule a transmission between the other network device and the UE. The scheduled transmission, which is cross-scheduled by one network device for the other network device, is communicated between the UE and the other network device according to the signaling. Communicating a transmission may involve sending the transmission by the UE and receiving the transmission by the other network device, or sending the transmission by the other network device and receiving the transmission by the UE.

### CROSS-REFERENCE TO RELATED APPLICATIONS

This application is a continuation of International Application No. PCT/CN2021/103223, filed on Jun. 29, 2021, which is hereby incorporated by reference in its entirety.

### TECHNICAL FIELD

This application relates generally to communications, and in particular to switching between terrestrial and non-terrestrial links in wireless communication networks.

### BACKGROUND

Some current cellular systems are strictly terrestrial systems, in which network infrastructure uses so-called terrestrial base stations. Mobility management procedures in such cellular systems are based on measurements of reference signals sent by serving and non-serving cells. Similarly, the current mobility reporting framework is premised around cell-based events, such as one cell becoming stronger than another cell. Such cell-based events are typically based on Reference Signal Received Power (RSRP) measurements, with the premise that cellular links are such that a communication device at only one end of the link, and in particular User Equipment (UE), is mobile.

Satellite-based systems are defined independently from cellular systems, and have their own set of signals and channels for communications with UEs, for navigation purposes for example. However, UEs cannot be seamlessly handed over from terrestrial network nodes to non-terrestrial network nodes such as satellites because the terrestrial and non-terrestrial network nodes are using different signals and channels that are defined as parts of different systems.

Another potential issue with terrestrial and non-terrestrial systems is that such systems typically do not occupy the same frequencies due to different spectrum allocation policies. This results in terrestrial and non-terrestrial systems using not only different signals and channels, but also different frame structures, making these systems further incompatible with each other.

Efficient handover or switching between terrestrial and non-terrestrial subsystems in integrated terrestrial and non-terrestrial communication networks remains a challenge. In conventional “break-before-make” handover procedures, for example, there is a time interval during which a UE is not connected to a network.

### SUMMARY

Some embodiments of the present disclosure provide solutions for handling switching between different types of links or subsystems, such as terrestrial and non-terrestrial links or subsystems, that use different signals and channels. Such links or subsystems are not conventionally integrated in such a way that they can provide seamless user experience under mobility. According to embodiments disclosed herein, terrestrial and non-terrestrial network nodes communicate with each other such that UEs that are switching between terrestrial and non-terrestrial links with a terrestrial network node and a non-terrestrial network node, can do so without experiencing interruptions.

Disclosed embodiments include a method performed by a UE in an integrated wireless communication network that includes terrestrial and non-terrestrial network devices. Such a method may involve receiving signaling from a first network device to schedule a transmission between a second network device and the UE, communicating the transmission with the second network device according to the received signaling. One of the first network device and the second network device is a terrestrial network device, and the other of the first network device and the second network device is a non-terrestrial network device.

Another aspect of the present disclosure relates to a UE that includes a communication interface; a processor, coupled to the communication interface; and a non-transitory computer readable storage medium, coupled to the processor, storing programming for execution by the processor. The programming includes instructions to: receive signaling, from a first network device in an integrated wireless communication network that includes terrestrial and non-terrestrial network devices, to schedule a transmission between a second network device and the UE; and to communicate the transmission with the second network device according to the received signaling. As in the example method described above, one of the first network device and the second network device is a terrestrial network device and the other of the first network device and the second network device is a non-terrestrial network device.

An apparatus implementation is only one possible implementation of a non-transitory computer readable storage medium. A computer program product may comprise such a non-transitory computer readable storage medium storing programming that includes instructions to: receive, by a UE from a first network device in an integrated wireless communication network that includes terrestrial and non-terrestrial network devices, signaling to schedule a transmission between a second network device and the UE; and communicate, by the UE, the transmission with the second network device according to the received signaling. Again, one of the first network device and the second network device is a terrestrial network device and the other of the first network device and the second network device is a non-terrestrial network device.

Another method disclosed herein is performed by a first network device in an integrated wireless communication network that includes terrestrial and non-terrestrial network devices. Such a method may involve transmitting signaling to a UE, to schedule a transmission between the UE and a second network device in the integrated wireless communication network, with one of the first network device and the second network device being a terrestrial network device and the other of the first network device and the second network device being a non-terrestrial network device.

In an apparatus embodiment, a first network device for an integrated wireless communication network that comprises terrestrial and non-terrestrial network devices may include a communication interface, a processor coupled to the communication interface, and a non-transitory computer readable storage medium coupled to the processor and storing programming for execution by the processor. The programming includes instructions to transmit signaling to a UE to schedule a transmission between the UE and a second network device in the integrated wireless communication network, and as in other embodiments one of the first network device and the second network device is a terrestrial network device and the other of the first network device and the second network device is a non-terrestrial network device.

In a computer program product comprising a non-transitory computer readable storage medium storing programming, the programming may include instructions to transmit to a UE, from a first network device in an integrated wireless communication network that comprises terrestrial and non-terrestrial network devices, signaling to schedule a transmission between the UE and a second network device in the integrated wireless communication network. One of the first network device and the second network device is a terrestrial network device and the other of the first network device and the second network device is a non-terrestrial network device.

In yet another aspect of the present disclosure, a method performed by a first network device in an integrated wireless communication network that comprises terrestrial and non-terrestrial network devices, may involve communicating a transmission with a UE according to scheduling of the transmission by a second network device in the integrated wireless communication network, wherein one of the first network device and the second network device is a terrestrial network device and the other of the first network device and the second network device is a non-terrestrial network device.

A first network device, for an integrated wireless communication network that comprises terrestrial and non-terrestrial network devices, may include a communication interface, a processor coupled to the communication interface, and a non-transitory computer readable storage medium coupled to the processor and storing programming for execution by the processor. The programming includes instructions to communicate a transmission with a UE according to scheduling of the transmission by a second network device in the integrated wireless communication network, one of the first network device and the second network device is a terrestrial network device, and the other of the first network device and the second network device is a non-terrestrial network device.

A computer program product consistent with yet another aspect of the present disclosure comprises a non-transitory computer readable storage medium storing programming that includes instructions to communicate, by a first network device for an integrated wireless communication network that comprises terrestrial and non-terrestrial network devices, a transmission with a UE according to scheduling of the transmission by a second network device in the integrated wireless communication network. As in other embodiments, one of the first network device and the second network device is a terrestrial network device and the other of the first network device and the second network device is a non-terrestrial network device.

Other aspects and features of embodiments of the present disclosure will become apparent to those ordinarily skilled in the art upon review of the following description.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram that provides a simplified schematic illustration of a communication system;

FIG. 2 is a block diagram illustrating another example communication system;

FIG. 3 is a block diagram illustrating example electronic devices and network devices;

FIG. 4 is a block diagram illustrating units or modules in a device;

FIG. 5 is a block diagram illustrating an example communication network that integrates terrestrial and non-terrestrial network devices;

FIG. 6 is a schematic diagram illustrating an integrated communication network and an example of link switching;

FIG. 7 is a block diagram illustrating an example of link switching and cross-link scheduling according to an embodiment;

FIG. 8 is a block diagram illustrating another example of link switching and cross-link scheduling that includes acknowledgements;

FIG. 9 is a signal flow diagram illustrating signaling according to an embodiment;

FIG. 10 is a signal flow diagram illustrating signaling according to another embodiment;

FIG. 11 is a block diagram illustrating another example of link switching and cross-link scheduling; and

FIG. 12 is a signal flow diagram illustrating signaling according to another embodiment.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

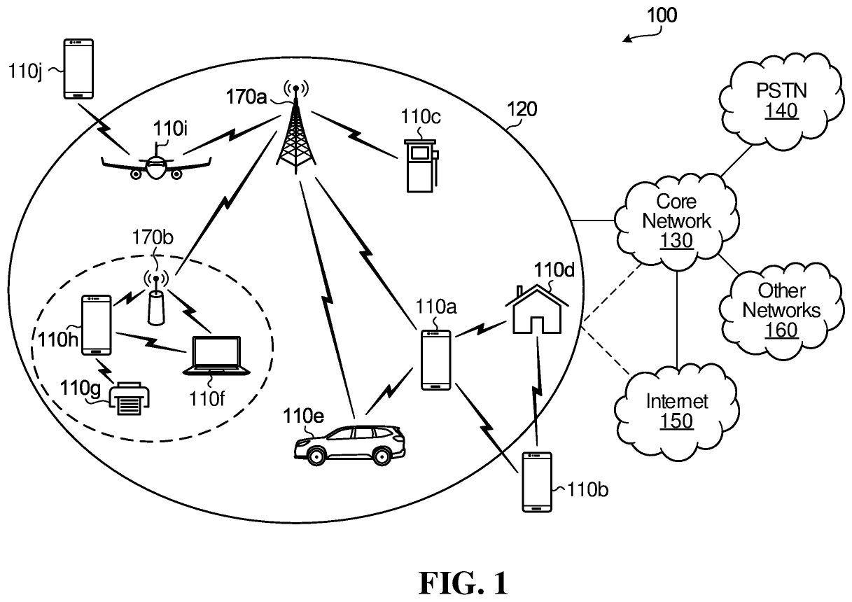

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network130 may be a part of the communication system and may be dependent or independent of the radio access technology used in the communication system 100. Also the communication system 100 comprises a public switched telephone network (PSTN) 140, the internet 150, and other networks 160.

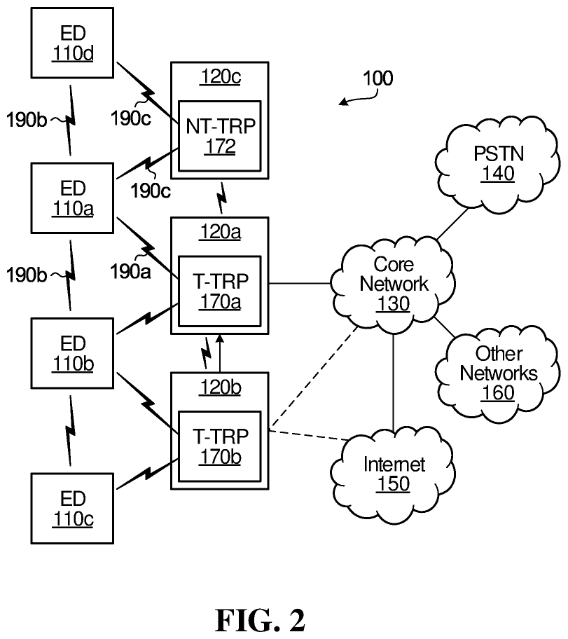

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such technologies.

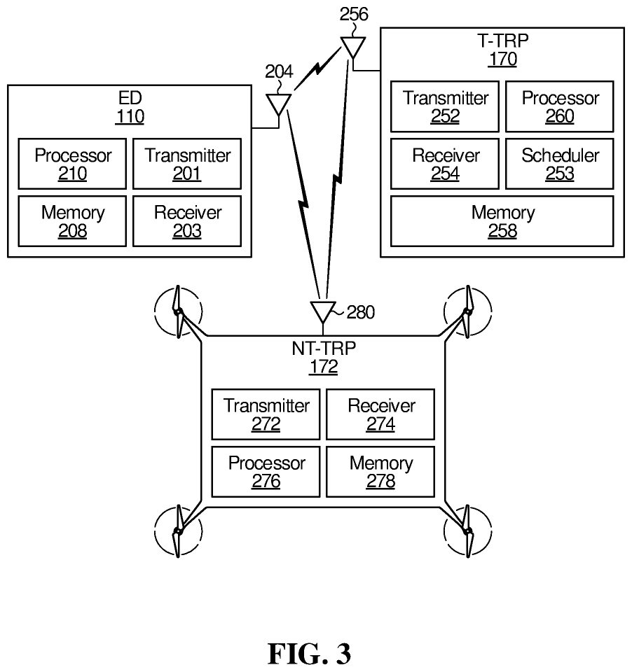

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an loT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

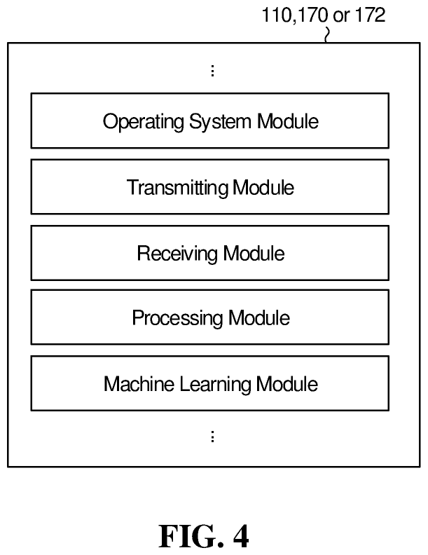

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A terrestrial communication system may also be referred to as a land-based or ground-based communication system, although a terrestrial communication system can also, or instead, be implemented on or in water. A non-terrestrial communication system may bridge coverage gaps for underserved areas by extending the coverage of cellular networks through non-terrestrial nodes. Non-terrestrial nodes may be key to ensuring global seamless coverage and providing mobile broadband services to unserved/underserved regions. For example, unserved or underserved regions may include regions in which it is not possible or feasible to implement terrestrial access-points/base-stations infrastructure, in areas like oceans, mountains, forests, or other remote areas.

The terrestrial communication system may be a wireless communication system using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communication system using satellite constellations like conventional Geo-Stationary Orbit (GEO) satellites that utilize broadcast public/popular contents to a local server, Low earth orbit (LEO) satellites that establish a better balance between large coverage area and propagation path-loss/delay, satellites in very low earth orbits (VLEO) enabling technologies substantially reducing the costs for launching satellites to lower orbits, high altitude platforms (HAPs) providing a low path-loss air interface for users with limited power budget, or Unmanned Aerial Vehicles (UAVs) (or unmanned aerial systems (UASs)) achieving a dense deployment because their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks. Emerging 3D vertical networks consist of many moving (other than geostationary satellites) and high altitude access points such as UAVs, HAPs and VLEOs.

In general, terrestrial networks include conventional cellular networks such as new radio (NR) and long term evolution (LTE) networks, and non-terrestrial networks refer to networks, or segments of networks, using an airborne or spaceborne vehicle for transmission. Examples of spaceborne vehicles include LEO satellites, medium earth orbit (MEO) satellites, GEO satellites, VLEO satellites, and highly elliptical orbit (HEO) satellites. Examples of airborne vehicles include HAPs, encompassing UASs including lighter than air (LTA) UASs and heavier than air (HTA) UASs, all operating in altitudes typically between 8 and 50 km. Airborne TRPs that typically operate at altitudes of approximately 100 m can be deployed on-board drone-type vehicles, and can be considered part of a terrestrial network (TN) or a non-terrestrial network (NTN), depending on whether they connect to a core network directly or through the NTN.

Integrated communication networks or systems as referenced herein integrate terrestrial network devices in a terrestrial network or subsystem and non-terrestrial network devices in a non-terrestrial network or subsystem, and can be useful to extend the coverage of terrestrial cellular networks and enhance service quality, for example. In some deployments, a terrestrial system offers primary service, a satellite system provides global seamless coverage, and flying TRPs provide for on-demand based regional service boost. Joint operation of a TN and an NTN in an integrated communication network may provide a 3D wireless communication system.

Although the present disclosure refers to terrestrial and non-terrestrial networks, systems, or subsystems, it should be appreciated that terrestrial and non-terrestrial components or links need not necessarily be implemented or provided in separate or distinct networks, systems, or subsystems. For example, embodiments disclosed herein may achieve tight or full integration between TN and NTN components such that from a UE perspective the TN and NTN components are part of the same RAN that employs a single radio access technology (RAT). Therefore, references to TN and NTN components or links as belonging to different networks, systems, or subsystems (TN and NTN, for example) should be interpreted accordingly, and not necessarily limited to deployments with separate and distinct terrestrial and non-terrestrial networks, systems, or subsystems.

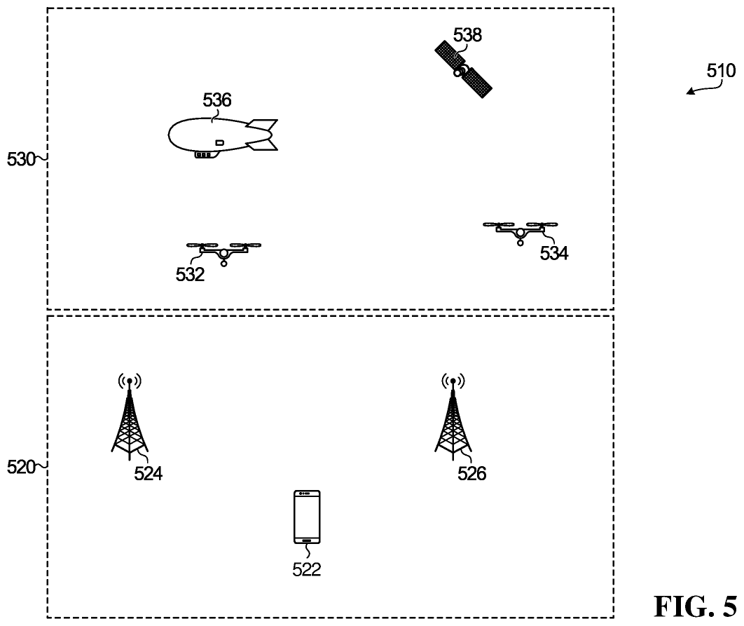

FIG. 5 is a block diagram illustrating an example communication network that integrates terrestrial and non-terrestrial network devices. The example communication network 510 includes both a terrestrial communication network or subsystem 520 and a non-terrestrial communication network or subsystem 530. The terrestrial communication network 520 and the non-terrestrial communication network 530 could be considered subnetworks or subsystems of the communication network 510. As shown, the terrestrial communication network 520 includes multiple terrestrial network devices 524, 526, and the non-terrestrial communication network 530 includes multiple non-terrestrial network devices 532, 534, 536, 538.

Examples of a terrestrial network device 524, 526 include TRPs, base stations, and other types of network nodes that are ground-based, including at least those referenced above. For example, a terrestrial network device may be mounted on or in a building or tower. A terrestrial communication network or terrestrial network device may also be referred to as a land-based or ground-based, and can also or instead include networks or devices that are implemented on or in water.

Non-terrestrial network devices such as those shown at 532, 534, 536, 538 may also include TRPs or other types of network nodes including at least those referenced above, and may be similar to terrestrial network devices in structure and function but with the exception that non-terrestrial network devices are not ground-based. Examples of non-terrestrial network devices include network devices that are carried by or otherwise implemented in drones as shown at 532, 534, HAPs as shown by way of example at 536, and satellites as shown at 538. Other examples of non-terrestrial network devices are possible but are not shown in FIG. 5, such as network devices that are carried by or otherwise implemented in balloons, planes, or other aircraft. Further examples of non-terrestrial network devices or nodes are also provided elsewhere herein.

Terrestrial network devices may be referred to or described by way of example as terrestrial TRPs or T-TRPs, and similarly non-terrestrial network devices may be referred to or described by way of example as non-terrestrial TRPs or NT-TRPs. Features disclosed herein in the context of a T-TRP or an NT-TRP are also applicable more generally to other types of terrestrial and non-terrestrial network devices, respectively.

FIG. 5 also illustrates a UE 522. Although the UE 522 is a terrestrial UE in the terrestrial communication network 520 in the example shown, this is intended to be a non-limiting example. An integrated communication network may also or instead provide communication services to non-terrestrial UEs. It should also be noted that although only a single UE is shown at 522 in FIG. 5, multiple UEs may operate with a communication network.

In general, non-terrestrial networks refer to networks, or segments of networks, using an airborne or spaceborne vehicle for transmission.

One aspect of the present disclosure relates to joint link switching and cross-link scheduling, between different terrestrial and non-terrestrial links, terrestrial and non-terrestrial networks, systems, subnetworks, or subsystems for example. Switching between terrestrial and non-terrestrial links is also referred to herein as cross-link mobility or cross-subsystem mobility. For ease of reference herein, embodiments will be described primarily in the context of TN and NTN links that are enabled, provided, or otherwise supported by TN and NTN nodes or network devices in a TN and an NTN. The TN and NTN may be considered parts, networks, systems, subnetworks, or subsystems of an integrated wireless communication system.

In the context of link switching and cross-link scheduling, a link refers generally to a connection through which a communication device such as a UE communicates with a network device. For example, a link may encompass a combination of physical layer resources and physical layer channels. Physical layer resources may be or include resources that are delineated based on any one or more of time, frequency, beam, and space, for example, and examples of physical layer channels include control channels and data channels.

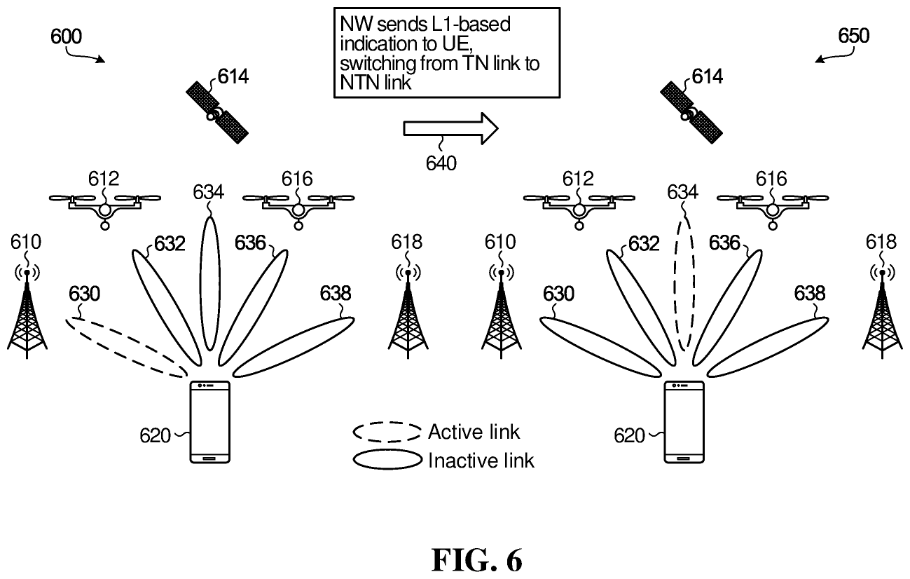

FIG. 6 is a schematic diagram illustrating an integrated communication network and an example of link switching. In FIG. 6, two representations of an integrated communication network are shown at 600, 650 to illustrate link switching. The integrated communication network includes a TN with T-TRPs shown by way of example at 610, 618, and NT-TRPs shown by way of example at 612, 614, 616. Links between a UE 620 and each TRP 610, 612, 614, 616, 618 are shown at 630, 632, 634, 636, 638. At 600, the link 630 is active, and after link switching the link 634 is active at 650.

The example of link switching FIG. 6 is from a TN link 630 to an NTN link 634. Link switching according to embodiments disclosed herein may provide a seamless mobility experience. Either or both of power saving and lower latency may also or instead be achieved by jointly instructing the UE 620 to switch between links and pre-scheduling data transmissions for a target network node (NT-TRP 614 in FIG. 6) to achieve interruption-free mobility. Communications between a spaceborne or airborne NTN node and a TN node may be exploited to enable TN/NTN link switching by UEs according to a link switching mechanism for TN to NTN link switching and/or NTN to TN link switching. Link switching as disclosed herein may avoid higher-layer signaling to a target subsystem, which is used in some conventional handover mechanisms.

In the example shown in FIG. 6, signaling to the UE 620 is illustrated generally by way of example at 640. A network node, which in this example is a TN node and in particular the T-TRP 610 for the active link 630, sends a Layer 1 (L1)-based indication to the UE 620 to switch links from the TN link 630 to the NTN link 634. The T-TRP 610 is also allowed to send physical layer control transmissions, to schedule physical layer data transmissions by another network node, which in this example is the NT-TRP 614. The UE 620 follows a timeline and procedure to carry out link switching across the different network nodes.

At 640, reference is made to the network (NW) sending an L1-based indication. Features disclosed in the context of such references are to be understood as applying to one or more network devices in a network. For example, as noted above, the T-TRP 610 is the network device that sends the indication at 640.

An example of joint link-switching and cross-link scheduling is considered in more detail below. In this example, a UE switches from a TN link to an NTN link in a scenario in which the TN and NTN nodes associated with the TN and NTN links are synchronized. In the context of this embodiment, the TN and NTN nodes are considered to be synchronized when they are using the same frame/subframe/slot/symbol positions.

For TN to NTN link switching, a UE is connected to a TN node, and a link with the TN node is considered active, as shown by way of example in FIG. 6 at 600, before TN to NTN link switching.

Some conventional network deployments include stationary base stations. UEs are assumed to be on the ground and it is assumed that when UEs connect to a terrestrial network, they transmit positioning reference signals to the network, allowing the network to infer the position of each UE. Depending on factors such as the time of the day and the locations of obstacles such as buildings, traffic demand can be different at different times and/or at different locations. In order to meet such on-demand and variable traffic constraints, satellites can be used to provide consistent user experience at expected service levels at different times and/or at different locations as UEs move.

A UE may have performed initial access or otherwise obtained an initial configuration from the network regarding link configuration corresponding to a given TN node and NTN node. This initial configuration can be provided to the UE using, for example, higher-layer signaling that is indicative of one of more link configuration parameters. Link configuration parameters may include, for example, mobility resources, control resources, data resources, etc. An example of a configuration for a link is provided below:

```
1> LinkConfigurationSet
  2> LinkId
  2> BeamAngularInformation
    3> AzimuthAngle
    3> ZenithAngle
  2> LinkConfiguration
    3> ControlChannelConfiguration
    3> DataChannelConfiguration
    3> ChannelStateInformationConfiguration
```

As shown, a configuration for a link may include a corresponding link identifier or identity, corresponding beam angular information using azimuth and zenith angles, and a corresponding link configuration, including a control channel configuration, a data channel configuration and a channel state information configuration. Configurations may include fewer, additional, and/or different fields or types of information in other embodiments.

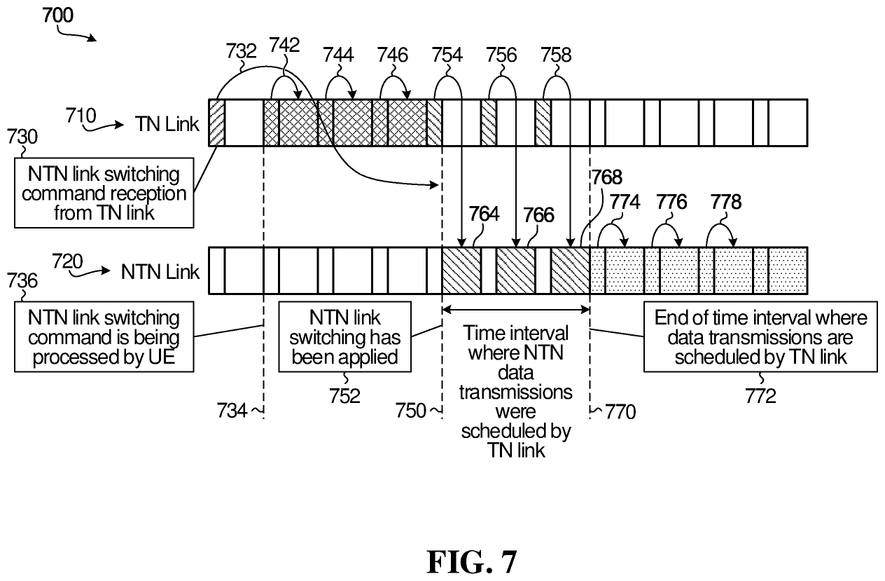

In order to provide seamless user experience under cross-link switching between TN and NTN links, the network and the UE follow a timeline in some embodiments, such that both network nodes and the UE follow mutually appreciated link switching rules or conditions. FIG. 7 is a block diagram illustrating an example of link switching and cross-link scheduling according to an embodiment.

The example 700 relates to switching from a TN link to an NTN link, and the streams at 710 and 720 represent control and data slots in which the UE receives control signaling and data transmitted by a TN node over a TN link and by an NTN node over an NTN link. Although embodiments are disclosed herein primarily with reference to reception of data in data slots, reception of transmissions by a UE is an illustrative example of communications. A UE may also or instead transmit or send transmissions. Similarly, a network device may transmit or send transmissions to a UE and/or receive transmissions from a UE. Embodiments may be applied to either or both of downlink and uplink communications.

In FIG. 7, also solely for illustrative purposes, smaller blocks are used to represent control slots, and the same size blocks are shown at 710 and 720 for the TN and NTN links. This is simply a convenient example, and should not in any way be interpreted as a requirement that TN and NTN links use exactly the same frame structure or operate at the same frequency. Embodiments disclosed herein are not limited to any particular relationship between TN and NTN link frame structures.

A link switching command is shown at 730, and is illustrative of signaling to indicate to the UE that the UE is to switch its link towards an NTN node in this example. It will take a certain amount of time for the UE to process a link switching command after such a command is received on the TN link. For example, a link switching command may carry beam-related information, and in that case it is expected that the operation of the UE steering its beam in the direction in accordance with the beam-related information received in the link switching command will take a corresponding processing time. Beam switching or steering is not typically instantaneous. Therefore, the UE is given a certain amount of time after receiving a link switching command, before the link switching command is considered to have been applied by the UE.

This amount of time is represented at 732 in FIG. 7. In the example 700, the UE begins processing the link switching command at 734, as indicated at 736, and at a time 750 the NTN link switching command has been applied as indicated at 752. In some embodiments, a link switching command is considered to have been applied when the link switching command has been processed by the UE.

An example of a link switching command is shown below:

```
1> LinkSwitchingCommand
  2> LinkId
  2> LinkSwitchingStartTime
  2> LinkSwitchingDuration
  2> BeamAngularInformation
```

In this example, the link switching command includes a link identifier or identity of the link to which the UE is to switch, a link switching start time at which the UE starts to receive data transmissions transmitted by the NTN link but scheduled by the TN link, and a link switching duration which indicates the length of time (in a time unit being used by the TN node, the NTN node, and the UE) during which the UE receives data transmissions transmitted by the NTN link but scheduled by the TN link. During the link switching duration, the UE receives the data transmissions transmitted by the NTN link but scheduled by the TN link, and after the link switching duration the UE receives data transmissions that are scheduled by and transmitted by the NTN link. A link switching command may also include beam angular information indicating, to the UE, the angular direction from where the transmissions from the NTN link are to be received. In other embodiments, a link switching command may include fewer, additional, and/or different fields or types of information. For example, a UE may already have received beam angular information in a configuration for a target link to which it is to switch, and such information then need not be included in a link switching command. Also, the description of fields in the above example relates to TN to NTN link switching. A link switching command for switching from an NTN link to a TN link may have the same or a similar structure.

The time between reception of the link switching command 730 and the link switching command application at 750 includes a time interval between 734 and 750 during which the TN node is still allowed to send control transmissions scheduling data transmissions, shown at 742, 744, 746.

After the link switching command has been applied at 750, the UE expects to receive data transmissions only from the NTN node over the NTN link. Control transmissions are received from the TN to schedule those data transmissions, but the data transmissions are by the NTN node over the NTN link. The time interval during which the UE receives data transmissions that are scheduled by a source node (the TN node in this example) but transmitted by a target node (the NTN node in this example) may be referred to as a link switching interval, and can be explicitly indicated to the UE, as a link switching duration in an L1-based link switching command for example.

During the link switching interval, shown in FIG. 7 between 750 and 770, the TN node is allowed to perform cross-link scheduling on behalf of the NTN node. Cross-link scheduling is shown in FIG. 7 at 754, 756, 758, for data transmissions received at 764, 766, 768 over the NTN link. Control transmissions from the TN node cross-scheduling data transmissions from the NTN node may include downlink control information (DCI) formats with fields such as a link identifier or identity associated with a target link to which the UE is to switch, a link switching end time, and beam angular information. DCI formats including a link identifier or identity inform the UE that a corresponding data transmission being scheduled by a transmission from a source link (the TN link in this example) is from another link (the target link, which is the NTN link in this example). A link switching end field may be used to indicate or identify a last data transmission sent by the target link but scheduled by the source link, so that the UE knows that the next control transmission is to be monitored on the target link. A beam angular information field may indicate, or further refine if beam angular information was previously provided to the UE, a region of space toward which the UE is to steer its receive beam to receive NTN data transmissions.

An example of such a DCI format for cross-link scheduling is shown below:

```
1> DCI-Format
  2> LinkId
  2> LinkSwitchingEnd
  2> BeamAngularInformation
```

As noted above for other examples, fewer, additional, and/or different fields or types of information may be used in other embodiments.

After the link switching interval ends at 770, the UE expects to receive control transmissions from the NTN node scheduling data transmissions from the NTN node, as indicated at 772. By that time, the TN link is no longer used by the UE and the NTN link has become the primary or active link of the UE. The end of the link switching interval marks the end of a link switching procedure and the NTN link is now the one being used by the UE, as shown at 650 in FIG. 6, for example. The UE then receives data transmissions, over the NTN link, that have been scheduled by control transmissions over the NTN link as shown at 774, 776, 778.

In the example 700, for joint link switching and cross-link scheduling by a TN node, a link switching command may indicate a time interval (represented at 732) following link switching command reception, after which data transmissions are scheduled by the TN node and transmitted by the NTN node. The TN node schedules TN link data transmissions while the link switching command is being processed by the UE, as shown between 734 and 750. The link switching command initiates cross-link scheduling, by the TN node, of NTN data transmissions during a link switching time interval between 750 and 770, and the target NTN node schedules data transmissions towards the UE to be received after link switching time interval ends.

TN and NTN links typically operate with different link propagation delays, and propagation delays tend to be higher for NTN links than TN links. A link switching time interval and cross-link pre-scheduling of NTN data transmissions may allow seamless and smooth handovers of a UE between TN and NTN links.

In some embodiments, upon receiving or in response to receiving an L1-based link switching command from a source node, a UE sends an acknowledgment to the source node, to confirm to the network that the UE did receive the command. Other acknowledgements may also or instead be provided. For example, transmissions scheduled by the source node before a link switching time interval may be acknowledged to the source node, and/or acknowledgements of data transmissions scheduled by the source node during a link switching time interval may be sent to the target node.

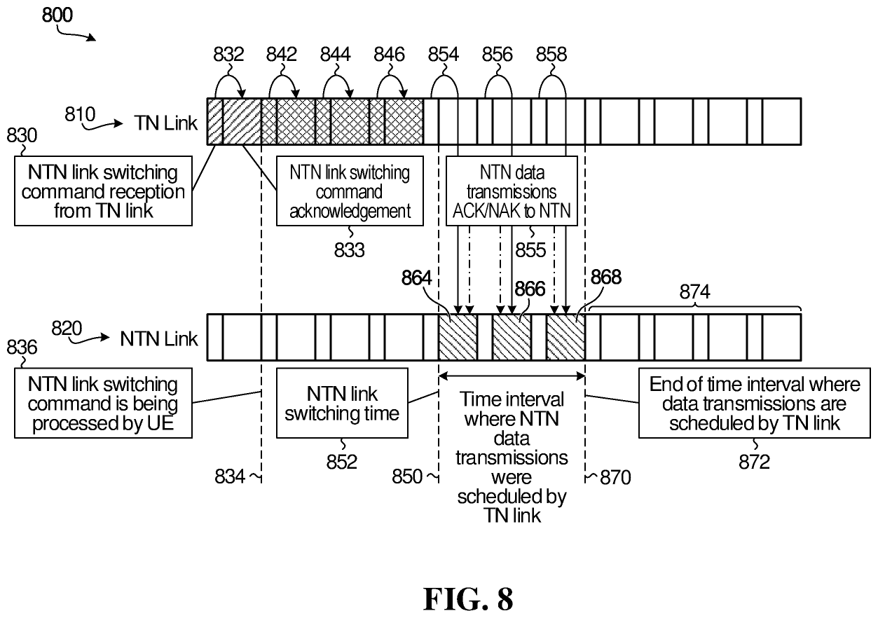

FIG. 8 is a block diagram illustrating another example of link switching and cross-link scheduling that includes acknowledgements. The example 800 is substantially the same as the example 700 in FIG. 7 and relates to link switching from a TN link to an NTN link. As in FIG. 7, the streams at 810 and 820 represent control and data slots in which the UE receives control signaling and data transmitted by a TN node over a TN link and by an NTN node over an NTN link. A link switching command is shown at 830. The UE begins processing the link switching command at 834 as indicated at 836. At a time 850, the NTN link switching command has been applied as indicated at 852. In the time interval between 834 and 850, the TN node sends control transmissions scheduling data transmissions as shown at 842, 844, 846. After the link switching command has been applied at 850, in the time interval between 850 and 870, the TN node performs cross-link scheduling at 854, 856, 858 for data transmissions received at 864, 866, 868 over the NTN link. After the link switching interval ends at 870, the UE expects to receive control transmissions from the NTN node scheduling data transmissions from the NTN node, as indicated at 872. The UE then receives data transmissions, over the NTN link, that have been scheduled by control transmissions over the NTN link as generally represented in FIG. 8 at 874.

The example 800 differs from the example 700 in FIG. 7 in that the UE transmits an acknowledgement of the link switching command to the TN node at 833. Another difference is illustrated generally at 855. The UE may also or instead acknowledge cross-link scheduled NTN data transmissions, to the NTN node that sent the data transmissions. Although not explicitly shown in FIG. 8, the UE may also or instead acknowledge either or both of data transmissions scheduled and transmitted by the TN node between 834 and 850, and data transmissions scheduled and transmitted by the NTN node at 874, after 870.

In some embodiments, a physical layer control acknowledgement or feedback mechanism for link switching commands and/or other signaling may be provided, at 833 for example. A physical layer acknowledgement or feedback mechanism may enable commands to be acknowledged without making use of a random access channel (RACH) procedure, for example. In typical mobility procedures used in 4G and 5G systems, a source cell sends a mobility command message to a UE, following which the UE initiates the RACH procedure in order to connect with a target cell. The RACH procedure is effectively an acknowledgement of the receipt of the mobility command message sent to the target cell, so that the network is aware that the UE received the mobility command message. A potential problem with using the RACH procedure is that the UE has to wait for a RACH response from the target cell before it can initiate two-way communication with the target cell, and this problem can be compounded in non-terrestrial systems due to inherently long propagation delays.

An acknowledgement or feedback mechanism may be based on uplink reference signal transmission from a UE, for example with a 1-bit acknowledgement for an L1-based Link Control Information (LCI) message embedded in the sequence design of an uplink reference signal, such as an uplink demodulation reference signal (UL DMRS), an uplink sounding reference signal (UL SRS), or an uplink positioning reference signal (UL PRS), for example. This 1-bit acknowledgement can be appended at a given location in the sequence of the uplink reference signal. Another possible acknowledgement or feedback option is a physical layer uplink transmission with a payload including 1-bit acknowledgement for an L1-based LCI message. These are illustrative examples, and other embodiments may employ similar or different acknowledgements or feedback for the receipt of an L1-based LCI message by the UE.

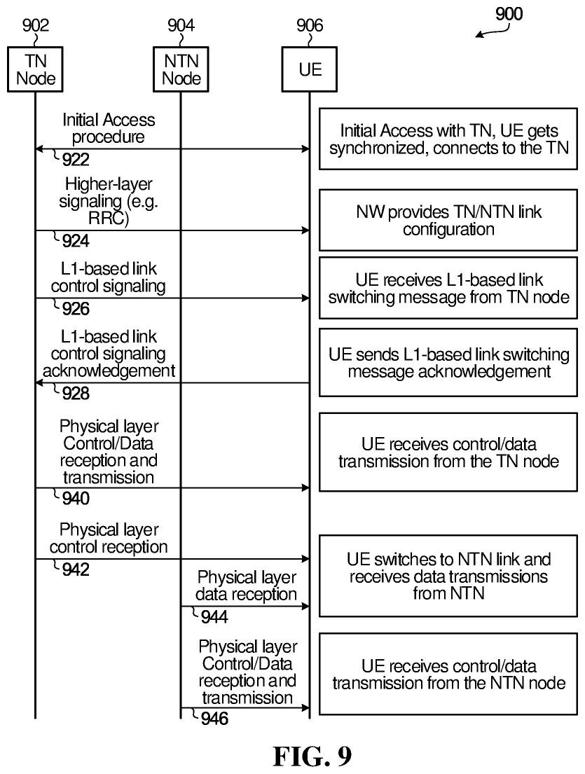

FIG. 9 is a signal flow diagram illustrating signaling according to an embodiment. The signal flow example 900 in FIG. 9 illustrates signaling between a TN node 902, an NTN node 904, and a UE 906 for TN link to NTN link switching.

In the example 900, it is presumed that the TN and NTN nodes 902, 904 are synchronized in time domain, and are using the same frame/subframe/slot/symbol position assumptions. The TN and NTN nodes 902, 904 use the same system frame number (SFN), and the same subframe/slot/symbol boundaries.

An initial access procedure between the UE 906 and the TN node 902 is illustrated at 922. Higher-layer signaling, which may be RRC signaling for example, is transmitted by the TN node and received by the UE 906 at 924. This is an example of signaling that is transmitted by a network device and received by a UE and is indicative of respective configurations for multiple links associated with different network devices, including TN and NTN links in this example.

The TN node 902 transmits a link switching message to the UE 906 at 926 to initiate a link switch from a TN link with the TN node to an NTN link with the NTN node 904. In FIG. 9, this message is shown by way of example as L1-based link control (LC) signaling. An LC message, or other signaling to initiate link switching, may carry such information as any one or more of: a target link identifier, a new UE radio network temporary identifier (RNTI), uplink timing advance associated with the NTN link, a time unit at which the UE is expected to acknowledge reception of the LC message or control signaling, beam information, and other link switching information disclosed by way of example elsewhere herein. An LC message or other control signaling may also or instead carry information about a time interval during which the source link schedules data transmissions for the target link, for example.

In the example 900, at 928 the UE 906 transmits and the TN node 902 receives an optional acknowledgement of the control signaling, shown by way of example as an L1-based acknowledgement. The UE also begins processing of the control signaling received at 926. UE processing of control signaling may begin before or after an acknowledgement is transmitted at 928, if an acknowledgement is transmitted at all.

During processing of a link switching command or other control signaling related to link switching, the UE 906 may continue to receive control and data transmissions from the TN node 902 over the existing TN link, as shown at 940. When such processing by the UE 906 has been completed, and the UE has applied a link switching command for example, the TN node 902 transmits and the UE receives one or more control transmissions at 942, which include scheduling information for the target NTN link with the NTN node 904. The control transmissions at 942 schedule the data transmissions from the NTN node 904, which are received by the UE 906 at 944. There may be one or more control transmissions and data transmissions at 942, 944. The TN node 902 and the NTN node 904 may negotiate or otherwise determine the time duration of cross-link scheduling at 942, 944, during which the UE 906 is expected to monitor for scheduling from the existing TN link of data transmissions on the target NTN link.

At the end of the switching time interval during which the UE 906 receives control transmissions from the TN node and data transmissions from the NTN node at 940, 942, the UE completes link switching and then receives control and data transmissions from the NTN node 904 over the target NTN link at 946. This finishes the link switching procedure.

The particular types of signaling in FIG. 9 and noted elsewhere herein are examples. Embodiments are not limited only to those types of signaling.

FIGS. 7 to 9 relate to illustrative embodiments. Features disclosed in the context of these embodiments may also or instead be applied to other embodiments. The feature set disclosed with reference to FIGS. 7 to 9, and other drawings or embodiments herein, is also not exhaustive.

For example, a MAC-layer based control layer may allow TN and NTN nodes to exchange information regarding such parameters as frame/subframe/slot/symbol timing, frequency band information, subcarrier location information, subcarrier spacing, etc. This allows the TN and NTN nodes to exchange information in order to synchronize their transmissions in the time domain, exchange information regarding TN and/or NTN link configurations to be transmitted to the UE, negotiate on how to carry out link switching by agreeing on link switching duration and beam directions, for example, to be used by the UE during a link switching procedure.

Other link switching parameters, such as any of the time intervals involved in link switching, may also or instead be exchanged or negotiated between TN and NTN nodes. Such information exchange may be carried out using MAC Control Element messages whose payload includes relevant information of TN/NTN link configurations, frame/subframe/slot/symbol timing information, frequency band information, and/or subcarrier location information, for example.

Information or signaling exchanged between TN and NTN nodes is not limited to link switching parameters. For example, TN and NTN nodes may also or instead exchange information associated with cross-link scheduling. Cross-link scheduling signaling may be transmitted to a first network device by a second network device, over the MAC layer for example, to schedule a transmission that is to be communicated with a UE by the first network device.

In some embodiments, TN and NTN nodes may exchange information about a UE's identity, such as cell RNTI (C-RNTI), to be used by the UE after a link switching procedure is completed. This allows the UE to start monitoring, detecting and demodulating physical layer signals or channels transmitted by the target link using the new UE identity.

In some embodiments, TN and NTN nodes may exchange information about scrambling identities to be used by the UE after a link switching procedure is completed. This allows the UE to start monitoring, detecting and measuring physical layer signals transmitted by the target link using the corresponding new scrambling identities. In some cases, the UE may be able to start monitoring, detecting and measuring physical layer signals such as Channel State Information Reference Signals (CSI-RS) during the link switching interval. Such CSI-RS may be monitored by the UE for the purpose of e.g. transmitting CSI reports for the target link.

In some embodiments, TN and NTN nodes may exchange information about ciphering keys to be used by the UE, after a link switching procedure is completed, for integrity protection and ciphering purposes. This allows the UE to receive physical layer transmissions carrying signaling data or user-specific data which are ciphered and integrity-protected by the network node on the target link.

In some embodiments, a UE is pre-configured with multiple link configurations, including a configuration for a TN link and a configuration for an NTN link for example. This need not preclude other configuration-related features. Individual configurations for different link can be updated in some embodiments, using change or “delta” configurations based on L1/L2-based signaling commands for example. Another feature that may be provided in some embodiments is ordering of links. Wireless links may be ordered based on any of various parameters, such as in a predetermined sequence with a TN as a primary or preferred link and an NTN link as a secondary or less preferred link.

Potential technical benefits of the foregoing examples, and others herein, may include smooth cross-link switching, in that UEs can be transferred between links, and from one network node and system or subsystem to another for example, seamlessly such that user experience is interruption-free. TN and NTN nodes may coordinate transmissions to allow such smooth link switching. Reduced UE complexity, signaling overhead, and link switching latency may also or instead be provided. For example, the timelines illustrated in FIGS. 7 and 8 and elsewhere herein may allow a network to control a link switching process in a way that accommodates UE complexity and latency of link switching. As an example, different classes of UEs may have different capabilities indicating how much time they need to reconfigure and steer their analog beam in a certain angular direction. This may have an impact on the link switching duration to be used during the link switching process. Another potential benefit is power savings. Providing configurations for multiple links to UEs in advance, for example, may contribute to reducing UE complexity, signaling overhead, and power consumption associated with link switching.

The examples described above with reference to FIGS. 7 to 9 presume that TN and NTN nodes are synchronized. Embodiments are not limited to that scenario. Joint link-switching and cross-link scheduling may also or instead be applied in UE switching between a TN link and an NTN link associated with TN and NTN nodes that are not synchronized, and are not using the same frame/subframe/slot/symbol positions. TN and NTN nodes may exchange information, over the MAC layer for example, in order to determine each-other's frame/subframe/slot/symbol positions. TN and NTN nodes may communicate with each other when they are synchronized, as referenced in the context of the examples above, but such communications may be especially useful to enable joint link switching and cross-link scheduling between nodes that are not synchronized.

For illustrative purposes, consider again the above example link switching from a TN link to an NTN link. In an unsynchronized scenario, the source TN node and the target NTN node are not using the same timing information, and the TN and NTN nodes exchange information, such as SFN, subframe/slot/symbol boundaries, numerologies, uplink timing advance, frequency band location, subcarrier location, etc. Such information is exchanged between the TN/NTN nodes on higher layers in some embodiments, using MAC layer-based signaling for example. Otherwise, link switching may be as described with reference to FIGS. 7 to 9 or elsewhere herein.

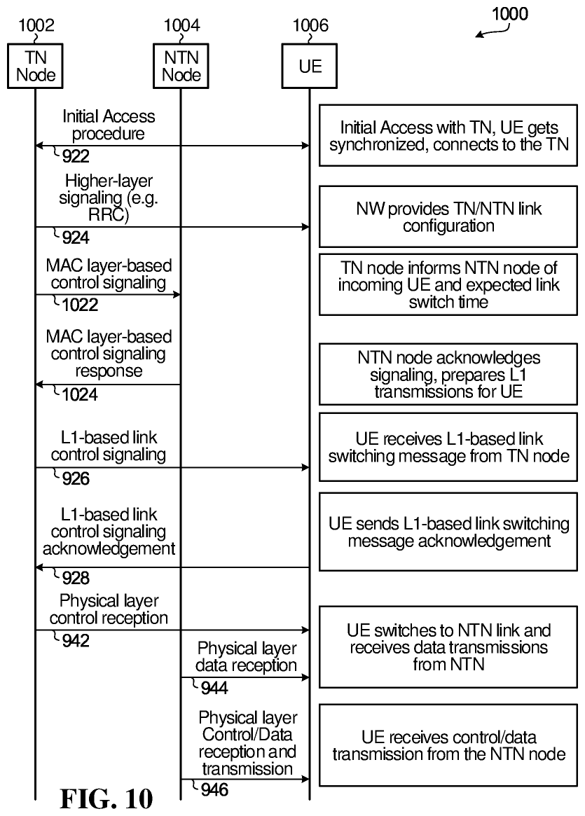

FIG. 10 is a signal flow diagram illustrating signaling according to another embodiment, to further illustrate link switching between links associated with unsynchronized network nodes. The signal flow example 1000 in FIG. 10 illustrates signaling between a TN node 1002, an NTN node 1004, and a UE 1006 for TN link to NTN link switching, and is substantially the same as the example 900 in FIG. 9, with the exception of TN/NTN node signaling at 1022, 1024. Also, to avoid congestion in the drawing, FIG. 10 does not illustrate physical layer control/data reception and transmission that is shown at 940 in FIG. 9, but such reception and transmission may be implemented in embodiments that include TN/NTN node signaling.

At 1022, the source node (which is the TN node 1002 in this example) transmits control signaling that is received by the target node (which is the NTN node 1004 in this example) to inform the target node of the “incoming” UE 1006, which will be switching to an NTN link associated with the NTN node in this example. The TN node 1002 may determine, based on an event or condition such as a UE mobility or link switching event, that the UE will be switching to the target link and transmit the control signaling to the NTN node 1004 at 1022 upon or responsive to making such a determination. The control signaling at 1022 is shown by way of example as MAC layer-based signaling.

The TN node 1002 may transmit such information as a time unit at which the UE is expected to have applied a link switching command, subframe/slot/symbol boundaries, uplink timing advance, frequency band location, and/or subcarrier location, for example. The NTN node 1004 acknowledges the control signaling from the TN node 1002 at 1024. In other embodiments, the NTN node may also or instead transmit information, such as its own timing information and/or other information associated with the NTN link, to the TN node 1002. Thus, exchanging information between source and target nodes may involve transmitting information by one of the nodes, receiving information by the other node, or both nodes transmitting information to and receiving information from each other.

Although not explicitly shown in FIG. 10, a link switching procedure may be halted in the event of an error or failure in the information exchange between unsynchronized TN and NTN nodes, if the NTN node 1004 does not at least acknowledge the control signaling at 1024 within a certain period of time and/or after a certain number of retransmission attempts at 1022 for example.

Another feature that may be provided in some embodiments but is not explicitly shown in FIG. 10 is transmission of scheduling signaling. Scheduling signaling may be transmitted from a source node to a target node to schedule, by the source node, a transmission between the target node and the UE.

The detailed examples above relate to link switching and cross-link scheduling for TN link to NTN link switching. NTN link to TN link switching embodiments are also possible, and features disclosed herein for TN to NTN link switching may also or instead be applied to NTN to TN link switching. For illustrative purposes, an example of NTN to TN link switching with TN and NTN nodes that are synchronized is considered below. Other embodiments and features disclosed herein in the context of TN to NTN switching, including those disclosed for unsynchronized nodes, may be applied to NTN to TN link switching.

For NTN to TN link switching, a UE is connected to a TN node, and a link with the TN node is considered active, as shown by way of example in FIG. 6 at 650. NTN to TN link switching is the inverse or in the reverse direction relative to the switching direction shown in FIG. 6, and for NTN to TN link switching a transition is from 650 to 600.

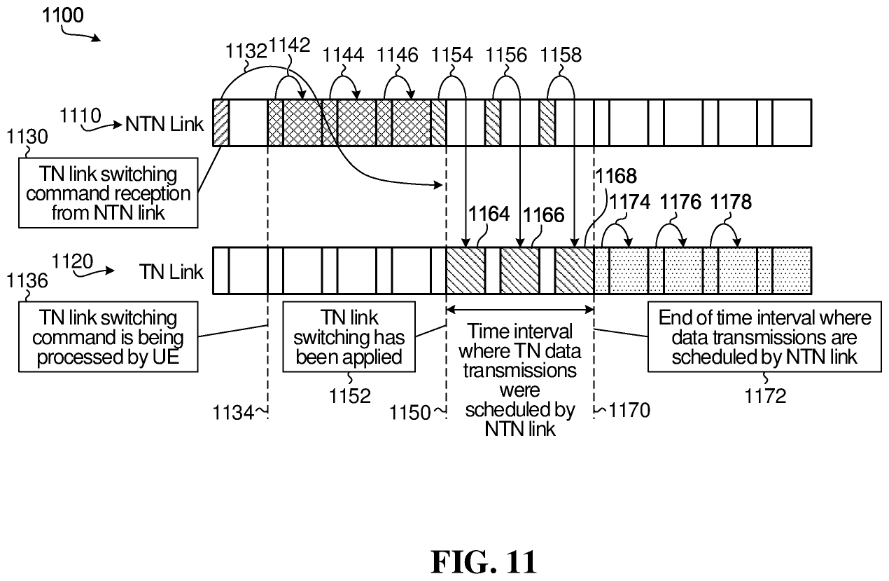

FIG. 11 is a block diagram illustrating another example of link switching and cross-link scheduling. The example in FIG. 11 is substantially similar to the example 700 in FIG. 7, but for link switching from an NTN link to a TN link. The streams at 1110 and 1120 represent control and data slots in which the UE receives control signaling and data transmitted by an NTN node over an NTN link and by a TN node over a TN link.

A link switching command is shown at 1130, and is another example of signaling to indicate to the UE that the UE is to switch its link, in this example towards a TN node. Time for the UE to process the link switching command is represented at 1132. The UE begins processing the link switching command at 1134, as indicated at 1136, and at a time 1150 the link switching command has been applied as indicated at 1152.

The time between the link switching command reception at and the link switching command application at 1150 includes a time interval between 1134 and 1150 during which the NTN node sends control transmissions scheduling data transmissions, shown at 1142, 1144, 1146.

After the link switching command has been applied at 1150, the UE expects to receive data transmissions only from the TN node over the TN link. Control transmissions are received from the NTN to schedule those data transmissions, but the data transmissions are by the TN node over the TN link. During the link switching interval, shown in FIG. 11 between 1150 and 1170, the NTN node performs cross-link scheduling on behalf of the TN node. Cross-link scheduling is shown in FIG. 11 at 1154, 1156, 1158, for data transmissions received at 1164, 1166, 1168 over the TN link.

Following the link switching interval, the UE expects to receive control transmissions from the TN node scheduling data transmissions from the TN node, as indicated at 1172. The NTN link is no longer used by the UE and the TN link has become the primary or active link of the UE. The end of the link switching interval marks the end of a link switching procedure and the TN link is now the one being used by the UE, as shown at 600 in FIG. 6, for example. The UE then receives data transmissions, over the TN link, that have been scheduled by control transmissions over the TN link as shown at 1174, 1176, 1178.

In the example 1100, for joint link switching and cross-link scheduling by an NTN node, a link switching command may indicate the time interval (represented at 1132) following link switching command reception, after which data transmissions are scheduled by the NTN node and transmitted by the TN node. The NTN node schedules NTN link data transmissions while the link switching command is being processed by the UE, as shown between 1134 and 1150. The link switching command initiates cross-link scheduling, by the NTN node, of TN data transmissions during a link switching time interval between 1150 and 1170, and the target TN node schedules data transmissions towards the UE to be received after link switching time interval ends.

In some embodiments, a UE sends an acknowledgment of a link switching command or other control signaling to a source NTN node. Because NTN nodes may be satellites located much further from the UE than TN nodes, wireless transmissions may take much longer to travel and reach an NTN node. Therefore, in some embodiments a source NTN node may schedule data transmissions towards the UE before an acknowledgment of a link switching command or other control signaling is received by the NTN node.

Other acknowledgements may also or instead be provided. For example, transmissions scheduled by a source NTN node before a link switching time interval may be acknowledged to the NTN node, and/or acknowledgements of data transmissions scheduled by the source NTN node during a link switching time interval may be sent to the target TN node.

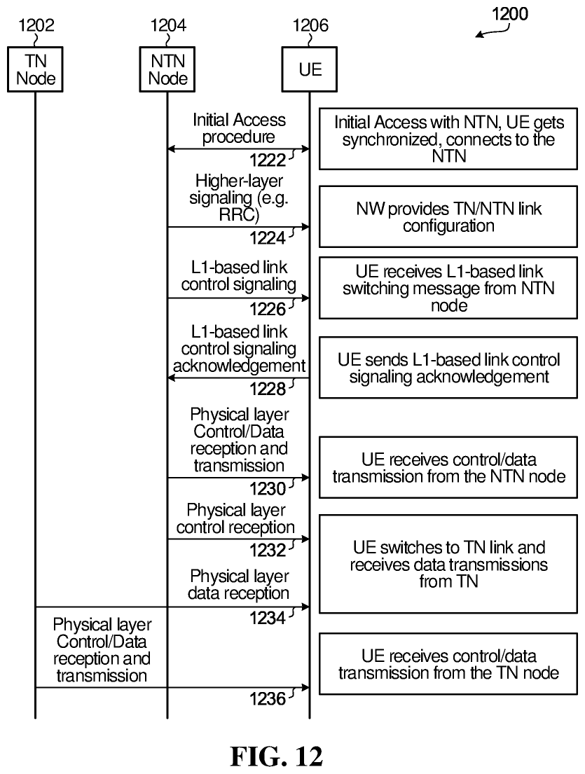

FIG. 12 is a signal flow diagram illustrating signaling according to another embodiment. The signal flow example 1200 in FIG. 12 illustrates signaling between a TN node 1202, an NTN node 1204, and a UE 1206 for NTN link to TN link switching.

In the example 1200, it is presumed that the TN and NTN nodes 1202, 1204 are synchronized. This is an illustrative example, and NTN to TN link switching embodiments are not in any way limited to synchronized nodes.

An initial access procedure between the UE 1206 and the NTN node 1204 is illustrated at 1222, and higher-layer signaling, which may be RRC signaling for example, is transmitted by the NTN node and received by the UE at 1224. This is another example of signaling that is transmitted by a network device and received by a UE and is indicative of respective configurations for multiple links associated with different network devices, including TN and NTN links in this example.

The NTN node 1204 transmits a link switching message to the UE 1206 at 1226 to initiate a link switch from an NTN link with the NTN node to a TN link with the TN node 1202. In FIG. 12, this message is shown by way of example as L1-based LC signaling. Examples of information that may be provided in an LC message or other signaling to initiate link switching are provided elsewhere herein.

In the example 1200, at 1228 the UE 1206 transmits and the NTN node 1204 receives an optional acknowledgement of the control signaling, shown by way of example as an L1-based acknowledgement. The UE 1206 also begins processing of the control signaling received at 1226. During processing of a link switching command or other control signaling related to link switching, the UE 1206 may continue to receive control and data transmissions from the NTN node 1204 over the existing NTN link, as shown at 1230. When such processing by the UE 1206 has been completed, and the UE has applied a link switching command for example, the NTN node 1204 transmits and the UE receives one or more control transmissions at 1232, which include scheduling information for the target TN link with the TN node 1202. The control transmissions at 1232 schedule the data transmissions from the TN node 1202, which are received by the UE 1206 at 1234. There may be one or more control transmissions and data transmissions at 1232, 1234. The TN node 1202 and the NTN node 1204 may negotiate or otherwise determine the time duration of cross-link scheduling at 1232, 1234, during which the UE 1206 is expected to monitor for scheduling from the existing NTN link of data transmissions on the target TN link.

At the end of the switching time interval during which the UE 1206 receives control transmissions from the NTN node and data transmissions from the TN node at 1230, 1232, the UE completes link switching and then receives control and data transmissions from the TN node 1202 over the target TN link at 1236.

The above examples encompass various embodiments. A method according to one embodiment is performed by a UE, and involves receiving signaling from a first network device to schedule a transmission between a second network device and the UE. One of the first network device and the second network device is a terrestrial network device and the other of the first network device and the second network device is a non-terrestrial network device. FIGS. 7 to 10 illustrate examples in which such signaling at 754/756/758, 854/856/858, 942 is received by a UE from a TN node, and FIGS. 11 and 12 illustrate examples in which such signaling at 1154/1156/1158, 1232 is received by a UE from an NTN node.

When such signaling is received, a UE may communicate a scheduled transmission with the second network device according to the received signaling. In the examples illustrated in the drawings, a UE receives cross-link scheduled transmissions from a second network element, as shown at 764/766/768, 864/866/868, 944, 1164/1166/1168, 1234. In other embodiments, a UE may also or instead transmit or send cross-link scheduled transmissions to a second network element. Without loss of generality, a device that expects to receive a scheduled transmission may monitor for such a transmission. For example, a device such as a UE or a network node may monitor for transmissions by attempting to detect transmissions. Transmissions may be either physical layer signals or physical layer channels. In some embodiments, detection of a signal or channel means that the amount of received power carried by the signal or channel exceeds a threshold of a detection algorithm implemented at the device. Transmitting, receiving, monitoring, and detection are all examples of operations that may be performed based on signaling that schedules transmissions.

A method may also involve a UE receiving further signaling from the first network device. An example of such further signaling is signaling that is or includes a link switching command indicating that the UE is to switch between a first link associated with the first network device and a second link associated with the second network device. Link switching commands or messages are shown by way of example in FIGS. 7 to 12. Although such commands or messages are referred to as link switching commands or messages, it should be appreciated that a UE need not necessarily be entirely switched or transferred from one network device to another. For example, it is possible that a UE may be configured to transmit and/or receive on multiple links simultaneously, which means that the UE may maintain an active connection or link with multiple network devices. Thus, a UE that receives a link switching command or message or communicates cross-link scheduled transmissions with a second network device need not necessarily drop its connection with a first network device. Multi-connectivity embodiments are also possible.

Link switching commands and messages are described by way of example elsewhere herein. In some embodiments, a link switching command may include any one or more of: a link identifier of the second link; a link switching start time at which the UE is to begin communicating transmissions with the second network device that are scheduled by the first network device; a link switching duration during which the UE is to communicate the transmissions with the second network device that are scheduled by the first network device and after which the UE is to communicate transmissions with the second network device that are scheduled by the second network device; a new UE RNTI for the UE; an uplink timing advance associated with the second link; a time unit at which the UE is to acknowledge reception of the further signaling; and beam information associated with the second link.

Some embodiments involve a UE transmitting, to the first network device from which it receives further signaling such as a link switching command, an acknowledgement of reception of that further signaling. The further signaling and the acknowledgement may be or include L1 signaling in some embodiments, although other types of signaling and acknowledgements may be used.

Signaling received from a first network device to schedule a transmission with a second network device may be or include DCI. Various examples of DCI content are disclosed elsewhere herein. In some embodiments, the DCI may be or include one or more fields including any one or more of: a link identifier of a second link associated with the second network device; a link switching end to indicate a last transmission that is communicated with the second network device and scheduled by the first network device; and beam angular information associated with the second link.

A method may involve other operations that enable link switching by might not necessarily be performed during a link switching procedure. For example, a UE method may involve receiving further signaling that is indicative of respective configurations for links associated with the first network device and the second network device. Such signaling may be received from the first network device or the second network device, or from another terrestrial or non-terrestrial network device in an integrated wireless communication network.

Signaling that provides configurations for links may be or include higher-layer signaling associated with initial access by the UE to the integrated wireless communication network in some embodiments. In the examples shown in FIGS. 9, 10, and 12, an initial access procedure is illustrated between a UE and a network device with which the UE has a connection when link switching is initiated. This is not necessarily the case, such as when a UE initially accessed an integrated wireless communication network through an initial access procedure with a network device A, then switched to a link with a different network device B, and then subsequently switched from a link with network device B to a link with another network device C. In this example, configurations for all three links may have been provided to the UE by network device A, even though network device A is not involved in the second link switching procedure between the links with network devices B and C.

Signaling that is indicative of configurations for links may be indicative of, for example, one of more of the following link configuration parameters for each of the links: mobility resources; control resources; data resources; a link identifier; beam angular information; a control channel configuration; a data channel configuration; and a channel state information configuration.

Regarding link switching procedures, the examples shown in FIGS. 7 to 9, 11, and 12 are illustrative of embodiments that involve three phases or stages. One stage involves processing of a link switching command or message, receiving scheduling from the first network device, and communicating transmissions with the first network device until the processing of the link switching command is complete. In FIG. 7, for example, this stage is between 730 and 750. During a link switching time interval and a second phase or stage, a method performed by a UE may involve receiving further signaling from the first network device to schedule a further transmission between the second network device and the UE, and communicating the further transmission with the second network device according to the received further signaling. FIG. 7 illustrates an example of such as second phase between 750 and 770. A third phase or stage, after the link switching time interval, may involve receiving scheduling from the second network device and communicating transmissions with the second network device, as shown by way of example after 770 in FIG. 7. Three phases or stages are also shown in FIGS. 8 and 11, and are believed to also be readily apparent from FIGS. 9 and 12 and the descriptions thereof. An embodiment as shown in FIG. 10 may also involve three phases or stages, although as indicated above the first phase (940 in FIG. 9) is not explicitly shown in FIG. 10 in order to avoid congestion in the drawing.

Regarding the third phase, after a link switching time interval a UE need not necessarily communicate only with a second network device. In multi-connectivity embodiments a UE may continue communicating with the first network device as well.

The examples are from the perspective of a UE, but the same or similar features may also or instead apply to other embodiments. Consider a method performed by a first network device in an integrated wireless communication network. Such a method may involve transmitting signaling to a UE, to schedule a transmission between the UE and a second network device. One of the first network device and the second network device is a terrestrial network device, and the other is a non-terrestrial network device in some embodiments.

Such a method may involve transmitting further signaling to the UE, and such further signaling may be or include a link switching command or message indicating that the UE is to switch between a first link associated with the first network device and a second link associated with the second network device. The link switching command or message examples provided above for UE methods also apply to network device methods.

A command or message acknowledgement, from the perspective of a network device that transmits further signaling to a UE, may involve receiving an acknowledgement of reception of the further signaling by the UE. L1 signaling, or other forms of signaling, may be used for command or message signaling and/or acknowledgements.

The DCI and DCI content examples provided above and/or elsewhere herein may be implemented in a method that is performed by a network device.

Further signaling indicative of respective configurations for links associated with the first network device and the second network device may be transmitted to a UE by a network device, as also described above. Higher-layer signaling associated with initial access by the UE to the integrated wireless communication network is an example, and the example link configuration parameters provided above and/or elsewhere herein may apply to network device embodiments.

Regarding the three phases or stages of link switching referenced above in the context of example UE methods, a source network device may actively participate in at least the first two stages, for example by scheduling and communicating transmissions with the UE during the first phase or stage until processing of a link switching command or message by the UE is completed, and then during a link switching time interval transmitting further signaling to the UE to schedule a further transmission between the second network device and the UE.

Some features disclosed herein may be especially relevant for network device methods. For example, when network devices are unsynchronized, a method may involve a first network exchanging information with a second network device to synchronize the first network device and the second network device. Exchanging such information may involve exchanging the information using MAC layer-based signaling in some embodiments.

Examples of information that may be exchanged between network devices are provided elsewhere herein and may include, for example, any one or more of: a configuration for a first link associated with the first network device; a configuration for a second link associated with the second network device; one or more of frame/subframe/slot/symbol timing information for the first link; one or more of frame/subframe/slot/symbol timing information for the first link; a time unit at which the UE is expected to have applied a link switching command; system frame number; one or more of subframe/slot/symbol boundaries; one or more numerologies; uplink timing advance; frequency band location; and subcarrier location.

These network device method examples focus primarily on a source network device that cross-schedules transmissions for a different link. Similar features may also or instead be provided for a target link or network device. For example, a method performed by a network device associated with a target link may involve communicating, by transmitting or receiving, a transmission with a UE according to scheduling of the transmission by another network device. With reference to FIG. 7 as an example, transmissions to the UE on the NTN link and received by the UE at 764, 766, 768 were transmitted by an NT network device according to scheduling of those transmissions by a terrestrial network device through the TN link, as shown at 754, 756, 758.

In the context of a target link or network device, a method may involve receiving, from a source network device, scheduling signaling to schedule the transmission, in which case communicating the transmission involves communicating the transmission with the UE according to the scheduling signaling received from the source network device.

The information exchange and examples described above in the context of example source network device methods also apply to target network device methods.

From the perspective of a target network device or link, the second and third phases of an example three-phase link switching procedure referenced above may involve, for a target network device, communicating a further transmission with the UE according to scheduling of the further transmission by a source network device during a link switching time interval, and, after the link switching time interval, scheduling and communicating transmissions with the UE.

These examples are illustrative of embodiments, and other features may also or instead be provided.

For example, after completing Initial Access, a UE may report one or more of its capabilities to the network using a Capability Report. In some embodiments, the UE may indicate a capability parameter indicating support of cross-link scheduling using TN and NTN nodes. In that case, a UE may expect to receive link switching commands from at least one network node belonging to at least one TN subsystem or at least one NTN subsystem.

In another embodiment, the UE may indicate a capability parameter indicating support for at least one value of processing time for link switching commands, where the processing time may be expressed using a certain time unit, such as milliseconds. In that case, the UE may expect to receive link switching commands from at least one TN or NTN network node, and the UE is not expected to receive data transmissions from a target network node until after the link-switching command processing time has elapsed.

In another embodiment, the UE may indicate a capability parameter indicating support for at least one value of link switching duration, where the link switching duration may be expressed using a certain time unit, such as milliseconds. In that case, the UE may expect to receive link switching commands from at least one TN or NTN network node, and the UE is not expected to receive control transmissions from a target network node until after the link switching duration time has elapsed.

In another embodiment, the UE may indicate a capability parameter indicating support for synchronous link switching operation. In that case, the UE is not expecting the network nodes involved in the link switching procedure to use different settings for frame/subframe/slot/symbol boundaries. Otherwise the UE's behavior may be undefined.

In another embodiment, the UE may indicate a capability parameter indicating support for asynchronous link switching operation. In that case, the UE is expected to receive transmissions from any one of the network nodes without restrictions in terms of the settings of frame/subframe/slot/symbol boundaries.

In another embodiment, the UE may indicate a capability parameter indicating support for intra-band link switching operation. In that case, the UE is expected to be able to perform a link switching procedure where the network nodes are using the same frequency band. Network nodes are not expected to send link switching messages to the UE where the different links are using different frequency bands.

In another embodiment, the UE may indicate a capability parameter indicating support for inter-band link switching operation. In that case, the UE is expected to be able to perform a link switching procedure where the network nodes are using different frequency bands. In some cases, support for inter-band link switching operation may imply support for intra-band link switching operation. Network nodes may then be allowed to send link switching messages to the UE where the different links are using the same frequency band or different frequency bands.

In another embodiment, the UE may indicate a capability parameter indicating support for only one type of link, TN or NTN for example, for link switching operation. In that case, the UE is not expected to receive a link switching command while a link switching procedure is already under way. If the UE were to receive a link switching command while a link-switching procedure is under way, then the UE behavior may discard the link switching command or the UE may follow some other behavior.

Apparatus embodiments are also possible. For example, an apparatus may include a processor and a non-transitory computer readable storage medium, such as the processor 210, 260, 276 and memory 208, 258, 278 in FIG. 3. Such an apparatus may be a UE or a network device. Other components, such as a communication interface to which the processor is coupled, may also be provided. Elements 201, 203, 204, 252, 254, 256, 272, 274, 280 are examples of communication interfaces that may be provided in some embodiments.

In an embodiment, the storage medium stores programming for execution by the processor, and the programming includes instructions to perform a method as disclosed herein. For example, the instructions, when executed by a processor, may cause the processor to perform any of various operations.

Another embodiment relates to a computer program product that includes a non-transitory computer readable storage medium storing programming. The programming includes instructions to perform a method as disclosed herein.

In some embodiments, the programming includes instructions to, or to cause a processor to, receive signaling, from a first network device in an integrated wireless communication network, to schedule a transmission between a second network device and a UE; and to communicate the transmission with the second network device according to the received signaling. An apparatus in which such programming is stored in a storage medium may be a UE, for example.

Some embodiments include any one or more of the following features, described by way of example elsewhere herein, in any of various combinations:
the programming further includes instructions to, or to cause a processor to, receive from the first network device further signaling comprising a link switching command;
such a link switching command may include any of various types of content, examples of which are provided elsewhere herein;
the programming further includes instructions to, or to cause a processor to, transmit to the first network device an acknowledgement of reception of the further signaling;
the further signaling and the acknowledgement are or include Layer 1 signaling;
the signaling to schedule the transmission is or includes DCI;
the DCI may be or include one or more fields, including any one or more of the examples provided elsewhere herein;
the programming further includes instructions to, or to cause a processor to, receive from the first network device, the second network device, or another one of the terrestrial and non-terrestrial network devices in the integrated wireless communication network, further signaling indicative of respective configurations for links associated with the first network device and the second network device;
such further signaling is or includes higher-layer signaling associated with initial access by the UE to the integrated wireless communication network;
the further signaling is indicative of one of more of the example link configuration parameters that are provided elsewhere herein for each of the links;
the programming further includes instructions to, or to cause a processor to: process a link switching command; and receive scheduling from the first network device and communicate transmissions with the first network device until the processing of the link switching command is complete;
the programming further includes instructions to, or to cause a processor to, during a link switching time interval: receive further signaling from the first network device to schedule a further transmission between the second network device and the UE; and communicate the further transmission with the second network device according to the received further signaling;
the programming further includes instructions to, or to cause a processor to, after the link switching time interval: receive scheduling from the second network device and communicate transmissions with the second network device.

In another embodiment, the programming includes instructions to, or to cause a processor to, transmit signaling from a first network device to a UE, to schedule a transmission between the UE and a second network device in an integrated wireless communication network. An apparatus in which such programming is stored in a storage medium may be the first network device in this example, or more generally a source network device with which the UE already has an active connection or link.

Some embodiments include any one or more of the following features, described by way of example elsewhere herein, in any of various combinations:
the programming further includes instructions to, or to cause a processor to, transmit from the first network device to the UE, further signaling comprising a link switching command;
such a link switching command may include any of various types of content, examples of which are provided elsewhere herein;
the programming further includes instructions to, or to cause a processor to, receive an acknowledgement of reception of the further signaling by the UE;
signaling;
the further signaling and the acknowledgement are or include Layer 1 the signaling to schedule the transmission is or includes DCI;
the DCI may be or include one or more fields, including any one or more of the examples provided elsewhere herein;
the programming further includes instructions to, or to cause a processor to, transmit to the UE further signaling indicative of respective configurations for links associated with the first network device and the second network device;
such further signaling is or includes higher-layer signaling associated with initial access by the UE to the integrated wireless communication network;
the further signaling is indicative of one of more of the example link configuration parameters that are provided elsewhere herein for each of the links;
the programming further includes instructions to, or to cause a processor to: schedule and communicate transmissions with the UE until processing of the link switching command by the UE is complete;
the programming further includes instructions to, or to cause a processor to, during a link switching time interval: transmit further signaling to the UE to schedule a further transmission between the second network device and the UE;
the programming further includes instructions to, or to cause a processor to, exchange information with the second network device to synchronize the first network device and the second network device;
the information includes any one or more of the examples provided elsewhere herein;
the programming further includes instructions to, or to cause a processor to, exchange the information using MAC layer-based signaling.

According to a further embodiment, the programming includes instructions to, or to cause a processor to, communicate, by a first network device, a transmission with a UE according to scheduling of the transmission by a second network device in an integrated wireless communication network. An apparatus in which such programming is stored in a storage medium may be the first network device in this example, or more generally a target network device.

Some embodiments include any one or more of the following features, described by way of example elsewhere herein, in any of various combinations:
the programming further includes instructions to, or to cause a processor to, receive, from the second network device, scheduling signaling to schedule the transmission, in which case the transmission is communicated with the UE according to the scheduling signaling received from the second network device;
the programming further includes instructions to, or to cause a processor to, exchange information with the second network device to synchronize the first network device and the second network device;
the information includes any one or more of the examples provided elsewhere herein;
the programming further includes instructions to, or to cause a processor to, during a link switching time interval: communicate a further transmission with the UE according to scheduling of the further transmission by the second network device;
the programming further includes instructions to, or to cause a processor to, after a link switching time interval: schedule and communicate transmissions with the UE.

Other features that could be implemented in apparatus embodiments or in non-transitory computer readable storage medium embodiments could be or become apparent, for example, from the method embodiments disclosed herein.

Features disclosed in the context of any embodiment are not necessarily exclusive to that particular embodiment, and may also or instead be applied to other embodiments.

For example, features disclosed herein may also or instead be applied to WiFi, ultra-reliable low latency communications (URLLC), and/or other multi-TRP systems. In the context of the present disclosure, similar link switching mechanisms may be implemented using WiFi radio access, possibly in the scope of URLLC for reliability or to guarantee certain latency requirements for example, and possibly in multi-TRP systems in which TN/NTN node features as disclosed by way of example above are applied to other types of TRPs.

What has been described is merely illustrative of the application of principles of embodiments of the present disclosure. Other arrangements and methods can be implemented by those skilled in the art.

For example, although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment could be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method performed by a user equipment (UE) in an integrated wireless communication network that comprises terrestrial and non-terrestrial network devices, the method comprising:
receiving signaling from a first network device to schedule a transmission between a second network device and the UE, one of the first network device and the second network device comprising a terrestrial network device and the other of the first network device and the second network device comprising a non-terrestrial network device; and
communicating the transmission with the second network device according to the received signaling.

2. The method of claim Error! Reference source not found., further comprising:
receiving further signaling from the first network device, the further signaling comprising a link switching command indicating that the UE is to switch between a first link associated with the first network device and a second link associated with the second network device.

3. The method of claim Error! Reference source not found., wherein the link switching command comprises any one or more of:
a link identifier of the second link;
a link switching start time at which the UE is to begin communicating transmissions with the second network device but scheduled by the first network device;
a link switching duration during which the UE is to communicate the transmissions with the second network device but scheduled by the first network device and after which the UE is to communicate transmissions with the second network device that are scheduled by the second network device;
a new UE radio network temporary identifier (RNTI) for the UE;
an uplink timing advance associated with the second link;
a time unit at which the UE is to acknowledge reception of the further signaling; or
beam information associated with the second link.

4. The method of claim Error! Reference source not found., further comprising:
transmitting, to the first network device, an acknowledgement of reception of the further signaling.

5. The method of claim Error! Reference source not found., wherein the further signaling and the acknowledgement comprise Layer 1 signaling.

6. The method of claim Error! Reference source not found., wherein the signaling comprises downlink control information (DCI).

7. A user equipment (UE) comprising:
a communication interface;
a processor, coupled to the communication interface;
a non-transitory computer readable storage medium, coupled to the processor, storing programming for execution by the processor, the programming including instructions to: receive signaling, from a first network device in an integrated wireless communication network that comprises terrestrial and non-terrestrial network devices, to schedule a transmission between a second network device and the UE, one of the first network device and the second network device comprising a terrestrial network device and the other of the first network device and the second network device comprising a non-terrestrial network device; and to communicate the transmission with the second network device according to the received signaling.

8. The UE of claim Error! Reference source not found., the programming further including instructions to receive further signaling from the first network device, the further signaling comprising a link switching command indicating that the UE is to switch between a first link associated with the first network device and a second link associated with the second network device.

9. The UE of claim Error! Reference source not found., wherein the link switching command comprises any one or more of:
a link identifier of the second link;
a link switching start time at which the UE is to begin communicating transmissions with the second network device but scheduled by the first network device;
a link switching duration during which the UE is to communicate the transmissions with the second network device but scheduled by the first network device and after which the UE is to communicate transmissions with the second network device that are scheduled by the second network device;
a new UE radio network temporary identifier (RNTI) for the UE;
an uplink timing advance associated with the second link;
a time unit at which the UE is to acknowledge reception of the further signaling; or
beam information associated with the second link.

10. The UE of claim Error! Reference source not found., the programming further including instructions to transmit, to the first network device, an acknowledgement of reception of the further signaling.

11. The UE of claim Error! Reference source not found., wherein the further signaling and the acknowledgement comprise Layer 1 signaling.

12. The UE of claim Error! Reference source not found., wherein the signaling comprises downlink control information (DCI).

13. The UE of claim Error! Reference source not found., wherein the DCI comprises one or more fields including any one or more of:
a link identifier of a second link associated with the second network device;
a link switching end to indicate a last transmission that is communicated with the second network device and scheduled by the first network device; and
beam angular information associated with the second link.

14. The UE of claim Error! Reference source not found., the programming further including instructions to receive further signaling, from the first network device, the second network device, or another one of the terrestrial and non-terrestrial network devices in the integrated wireless communication network, indicative of respective configurations for links associated with the first network device and the second network device.

15. A first network device for an integrated wireless communication network that comprises terrestrial and non-terrestrial network devices, the network device comprising:
a communication interface;
a processor, coupled to the communication interface; and
a non-transitory computer readable storage medium, coupled to the processor, storing programming for execution by the processor, the programming including instructions to: transmit signaling to a user equipment (UE), to schedule a transmission between the UE and a second network device in the integrated wireless communication network, one of the first network device and the second network device comprising a terrestrial network device and the other of the first network device and the second network device comprising a non-terrestrial network device.

16. The network device of claim Error! Reference source not found., the programming further including instructions to:
transmit further signaling to the UE, the further signaling comprising a link switching command indicating that the UE is to switch between a first link associated with the first network device and a second link associated with the second network device.

17. The network device of claim Error! Reference source not found., wherein the link switching command comprises any one or more of:
a link identifier of the second link;
a link switching start time at which the UE is to begin communicating transmissions with the second network device but scheduled by the first network device;
a link switching duration during which the UE is to communicate the transmissions with the second network device but scheduled by the first network device and after which the UE is to communicate transmissions with the second network device that are scheduled by the second network device;
a new UE radio network temporary identifier (RNTI) for the UE;
an uplink timing advance associated with the second link;
a time unit at which the UE is to acknowledge reception of the further signaling; or
beam information associated with the second link.

18. The network device of claim Error! Reference source not found., the programming further including instructions to:
receive an acknowledgement of reception of the further signaling by the UE.

19. The network device of claim Error! Reference source not found., wherein the further signaling and the acknowledgement comprise Layer 1 signaling.

20. The network device of claim Error! Reference source not found., wherein the signaling comprises downlink control information (DCI).
